(19) United States
(12) Patent Application Publication
(10) Pub. No.: US 2009/0077168 A1
(43) Pub. Date: Mar. 19, 2009

(54) ACCESS CONTROL METHOD AND ACCESS CONTROL DEVICE

(76) Inventor: Tamon SADASUE, Tokyo (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/197,413

(22) Filed: Aug. 25, 2008

(30) Foreign Application Priority Data
Sep. 13, 2007 (JP) 2007-237746

(51) Int. Cl. G06F 15/16

(52) U.S. Cl. 709/203

(57) ABSTRACT

A client device and a server device are connected to each other via a network. The client device sends an acquire request containing an identifier that indentifies the partial image data to the server device. The server device extracts the identifier from the acquire request, and acquires image information about the partial image data that corresponds to the identifier from an identifier table. Then the server acquires partial image data corresponding to the image information from a partial image data database and sends the acquired partial image data to the client device via the network.

### CROSS-REFERENCE TO RELATED APPLICATIONS

The present application claims priority to and incorporates by reference the entire contents of Japanese priority document 2007-237746 filed in Japan on Sep. 13, 2007.

### BACKGROUND OF THE INVENTION

1. Field of the Invention

The present invention relates to a technology for sending image data that is desired by a client device from a server device to the client device.

2. Description of the Related Art

With the popularization of network connectable terminals, such as personal computers or cellular phones, there have been arisen various needs about image data including needs for access suitable for a screen having predetermined size and resolution. Moreover, there have been appeared various image-data compression schemes including a joint photographic expert group (JPEG) standard.

Hierarchical coding schemes including a JPEG 2000 are proposed to satisfy such needs about image data. Hierarchically-coded high-quality image data can be stretched with various quality levels by specifying a partial code of the image data. Thus, the hierarchical coding schemes implement various access requests from various types of terminals having different image display functions such as a personal computer, a mobile terminal, and a television set. The protocol for sending/receiving image data coded based on the JPEG 2000 is called a JPEG 2000 interactive protocol (JPIP). The JPIP is prescribed in ISO/IEC 15444-9.

Japanese Patent Application Laid-open No. 2004-208266 discloses a system in which a server device and a client device communicate with each other directly using the JPIP. The client device requests the server device to send only a desired partial code about the image data. However, this system is not designed from the viewpoint of the security, so that any client device can acquire all the layers of the image data.

In contrast, Japanese Patent Application Laid-open No. 2003-324418 discloses a technology for encrypting, if image data includes hierarchically-coded layers, data in each layer while giving different access rights to users depending on a type of key possessed by each user, thereby defending security.

However, in Japanese Patent Application Laid-open No. 2003-324418, all the layers of the image data are any way distributed to every user. In other words, for a user who can decode only a predetermined partial code, the codes other than the predetermined partial code are unnecessary. Transmission of unnecessary codes only increases workload on the network and memory usage and may cause transmission delay on the network, which makes the system efficiency worse. Moreover, the system needs to include a unique encryption/decryption system between the image-data provider and the image-data acquirer, which makes the system more complicated.

### SUMMARY OF THE INVENTION

It is an object of the present invention to at least partially solve the problems in the conventional technology.

According to an aspect of the present invention, there is provided an access control method used in an image distribution system, the image distribution system including a client device and a server device connected to each other via a network, the server device stores therein image data and performs the access control method upon receiving an acquire request from the client device to acquire partial image data. The access control method includes extracting a first identifier from the acquire request, the first identifier being used for identifying the partial image data; first acquiring including acquiring first information corresponding to the first identifier from an identifier table, wherein the first information is information about the partial image data, and the identifier table includes the first information and the first identifier in an associated manner; second acquiring including acquiring partial image data corresponding to the first information; and sending acquired partial image data to the client device via the network.

According to another aspect of the present invention, there is provided an access control method used in an image distribution system including a client device, a plurality of server devices, and an access control device connected to each other via a network, the server devices store therein image data, and the access control device performs the access control method upon receiving an acquire request from the client device to acquire a plurality of pieces of partial image data from one or more of the server devices. The access control method including extracting a first identifier from the acquire request, the first identifier being used for identifying the partial image data; first acquiring including acquiring first information corresponding to the first identifier from an identifier table, wherein the first information is information about the partial image data and the second information is information about the one or more server devices that stores therein the partial image, and the identifier table includes the first information, the second information, and the first identifier in an associated manner; second acquiring including acquiring the pieces of partial image data corresponding to the first information from the one or more server devices corresponding to the second information; merging the acquired pieces of partial image data thereby obtaining merged image data; and sending the merged image data to the client device via the network.

According to still another aspect of the present invention, there is provided an access control device used in a server device that is used in an image distribution system, the image distribution system including a client device and the server device connected to each other via a network, the server device stores therein image data. The access control device including an extracting unit that extracts a first identifier from an acquire request, the first identifier being used for identifying the partial image data, the acquire request being sent from the client device the server device to acquire partial image data from the server device; a information acquiring unit that acquires first information corresponding to the first identifier from an identifier table, wherein the first information is information about the partial image data, and the identifier table includes the first information and the first identifier in an associated manner; an image-data acquiring unit that acquires partial image data corresponding to the first information; and a transmitting unit that transmits the partial image data acquired by the image-data acquiring unit to the client device via the network.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram of an image distribution system according to a first embodiment of the present invention;

FIG. 2 is a block diagram for explaining data transactions in an image processing apparatus shown in FIG. 1;

FIG. 3 is an example of contents of an identifier table according to the first embodiment;

FIG. 4 is a flowchart of an image distribution process according to the first embodiment;

FIG. 5 is a block diagram of an image distribution system according to a second embodiment of the present invention;

FIG. 6 is an example of contents of an identifier table according to the second embodiment;

FIG. 7 is a flowchart of an image distribution process according to the second embodiment;

FIG. 8 is a block diagram of an image distribution system according to a third embodiment of the present invention;

FIG. 9 is a flowchart of a sharing process according to the third embodiment;

FIG. 10 is an example of contents of a permission message created by an access control unit shown in FIG. 8;

FIG. 11 is an example of contents of a destination management table;

FIG. 12 is a schematic diagram of the structure of JPEG 2000-based image data; and

FIG. 13 is a schematic diagram of the structure of tile-stream data shown in FIG. 12.

### DETAILED DESCRIPTION OF THE PREFERRED EMBODIMENTS

Exemplary embodiments of the present invention are described in detail below with reference to the accompanying drawings. Same or equivalent components used in different embodiments are denoted with the same reference numerals, and the same description is not repeated.

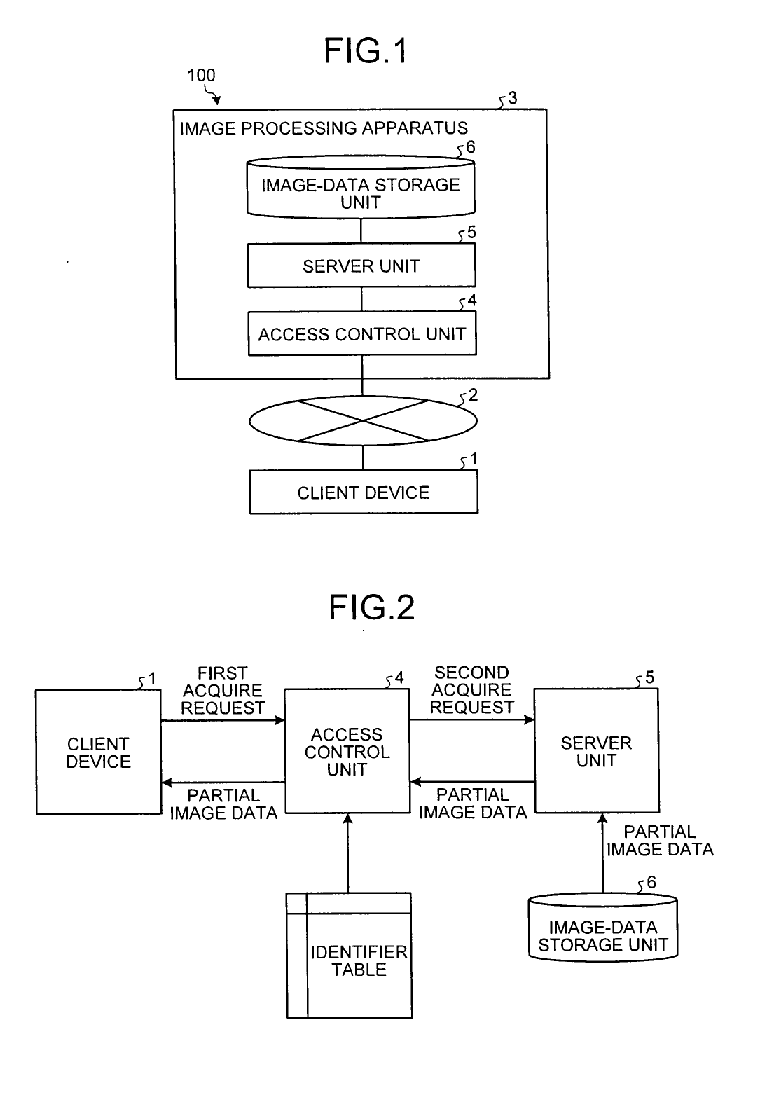

FIG. 1 is a block diagram of an image distribution system 100 according to a first embodiment of the present invention. The image distribution system 100 uses an access-control method according to the first embodiment.

The image distribution system 100 includes a client device 1, a network 2, and an image processing apparatus 3 that works as a server device. The client device 1 and the image processing apparatus 3 are connected to each other via the network 2 such as the Internet.

Predetermined software programs are installed in the image processing apparatus 3 so that the image processing apparatus 3 can work as a World Wide Web (WWW) server. The software programs include, for example, a JPIP server program. The JPIP is a communications protocol for the JPEG 2000. The image processing apparatus 3 can be any device that has a capability to process image data such as a workstation or a personal computer.

The client device 1 is, for example, a workstation, a personal computer, a cellular phone, a personal handy-phone system (PHS), a portable digital assistant (PDA), or the like. Predetermined software programs are installed in the client device 1 including a software program for browsing web pages, a software program for decoding data that is coded based on the JPEG 2000 and displaying the decoded data, and a software program for implementing JPIP-based client features.

The image processing apparatus 3 includes an access control unit 4, a server unit 5, and an image-data storage unit 6. The access control unit 4 and the server unit 5 work together to send/receive image data by using the JPIP. The image-data storage unit 6 includes a hard disk device (HDD) capable of storing therein a large amount of image data. Compressed image data coded based on the JPEG 2000 is stored in the image-data storage unit 6.

FIG. 2 is a block diagram for explaining data transactions in the image processing apparatus 3. The access control unit 4 receives from the client device 1 a request (hereinafter, “first acquire request”) to acquire desired image data. The first acquire request contains specifying data that specifies the desired image data. The specifying data, for example, is a uniform resource identifier (URI) for the desired image data. Upon receiving the first acquire request, the access control unit 4 generates a request (hereinafter, “second acquire request”) to acquire a desired partial code that matches with the specifying data included in the first acquire request, and sends the second acquire request to the server unit 5.

Upon receiving the second acquire request, the server unit 5 acquires the desired partial image data from the image-data storage unit 6 based on data contained in the second acquire request, and sends the acquired partial image data to the access control unit 4.

Upon receiving the partial image data, the access control unit 4 sends the partial image data to the client device 1.

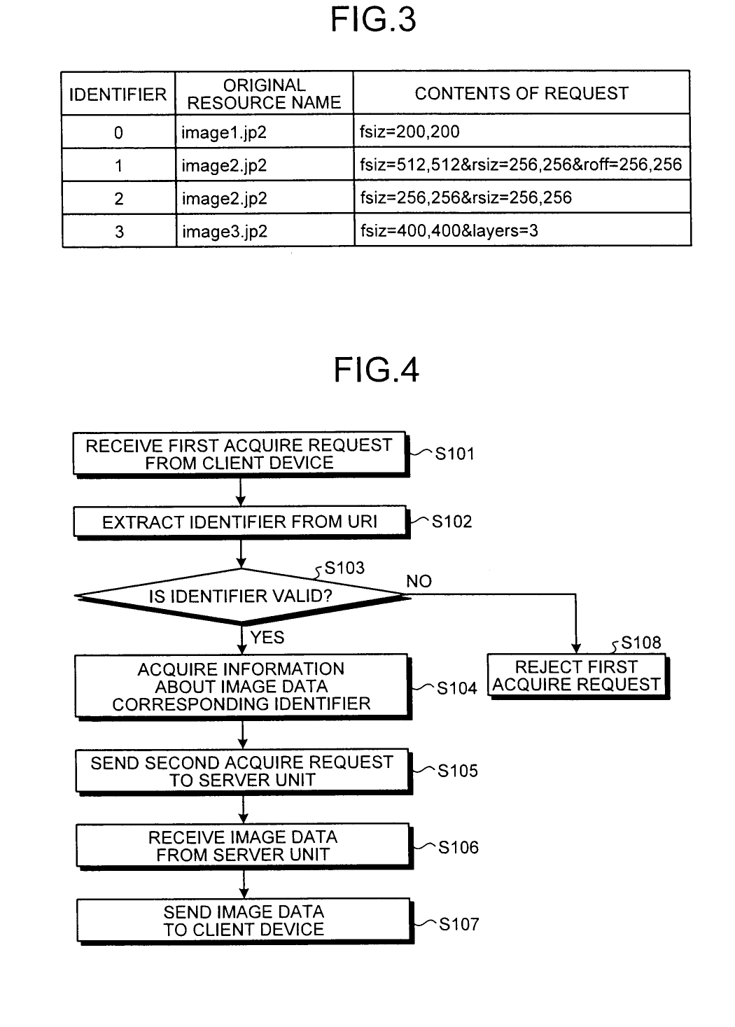

The access control unit 4 includes an identifier table, and uses this identifier table to generate the second acquire request. FIG. 3 is an example of contents of the identifier table according to the first embodiment. The identifier table includes identifiers, such as 0, 1, 2, 3, and original resource name and contents of request for each of the identifier. The client device 1 sends a URI (specifying data) including a specific identifier to the access control unit 4. The access control unit 4 identifies image data corresponding to the specific identifier by referring to the identifier table. The original resource name is a file name of image data to be acquired. The request contains information about partial image data to be acquired, described in syntax of the JPIP standard. More particularly, the request contains a combination of requests including any of a frame size request (fsiz) indicative of resolution of the source image, a region request (rsiz) indicative of target region, a region offset request (roff) indicative of position from the upper-left corner, a quality layer request (layers) indicative of quality, a component request (comps), and the like. Details of those requests are prescribed in “Client Request”, Annex C, ISO/IEC 15444-9. The identifier is based on target ID of the JPIP standard.

Although it has been stated above that the access control unit 4 and the server unit 5 employ a coding scheme and a transmission protocol based on the JPIP, they can employ a coding scheme and a transmission protocol that is not based on the JPIP. The access control unit 4 and the server unit 5 can employ FlashPix as the image-data coding scheme and Internet Imaging Protocol (IIP).

Given below is an explanation about operations of the image distribution system 100 with reference to FIG. 4. FIG. 4 is a flowchart of an image distribution process according to the first embodiment.

Upon receiving the first acquire request from the client device 1 (Step S101), the access control unit 4 extracts the identifier from the URI in the first acquire request to identify information about the partial image data to be acquired (Step S102). For example, the client device 1 sends a character string as the first acquire request using a GET method or a POST method and the access control unit 4 acquires the character string by executing a common gateway interface (CGI) program.

The access control unit 4 determines whether the extracted identifier is valid (Step S103). For example, if the extracted identifier is in an encrypted form, the access control unit 4 decrypts the extracted identifier, and determines whether the decrypted identifier is valid. Validity of the identifier can be determined based on checksum.

If the identifier is valid (Yes at Step S103), the access control unit 4 acquires from the identifier table the original resource name and the contents of request that match with the identifier (Step S104). The access control unit 4 generates the second acquire request from the acquired original resource name and the acquired contents of request, and sends the second acquire request to the server unit 5 (Step S105).

If the identifier is not valid (No at Step S103), the access control unit 4 rejects the first acquire request (Step S108), and the process control goes to end.

Upon receiving the second acquire request from the access control unit 4, the server unit 5 acquires from the image-data storage unit 6 the partial image data that matches with the original resource name and the contents of request in the second acquire request, and sends the acquired partial image data to the access control unit 4 (Step S105). Upon receiving the partial image data (Step S106), the access control unit 4 sends the partial image data to the client device 1 as a response to the first acquire request (Step S107).

In this manner, the client device 1 embeds an identifier into a first acquire request and sends the first acquire request to the image processing apparatus 3. The image processing apparatus 3 acquires image data based on the identifier in the first acquire request and returns the acquired image data to the client device 1. In other words, the image processing apparatus 3 sends only the minimum coded image data to the client device 1. As a result, the possibility of transmission delay, the workload on the network, and the memory usage decrease compared with the conventional technologies because unnecessary data is not sent to the client device 1. Moreover, because the identifier works as a simple key, the security for the image data increases.

Furthermore, because there is no need to include the unique encryption/decryption system between the provider (the image processing apparatus 3) and the acquirer (the client device 3) of the image data, the image distribution system 100 has the structure simpler than that of the conventional image distribution system.

Although the access control unit 4 and the server unit 5 are described as different units, the access control unit 4 and the server unit 5 can be combined into one unit.

The image distribution system 100 included only one server unit 5. In contrast, an image distribution system according to a second embodiment of the present invention described below includes a plurality of server devices.

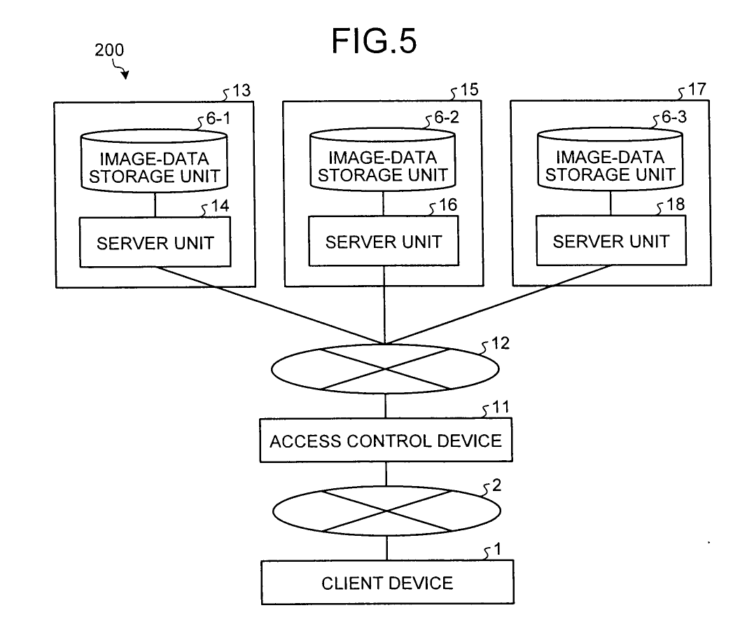

FIG. 5 is a block diagram of an image distribution system 200 according to the second embodiment. The image distribution system 200 uses an access-control method according to the second embodiment. The image distribution system 200 includes the client device 1, the network 2, an access control device 11, a network 12, and a plurality of image storage devices 13, 15, and 17 that work as server devices. The client device 1 and the access control device 11 are connected to each other via the network 2. The access control device 11 is connected to each of the image storage devices 13, 15, and 17 via the network 12. The networks 2 and 12 can be the Internet, a local area network (LAN), or the like. Although three image storage devices are shown in FIG. 5, the image storage devices can be less than three or more than three.

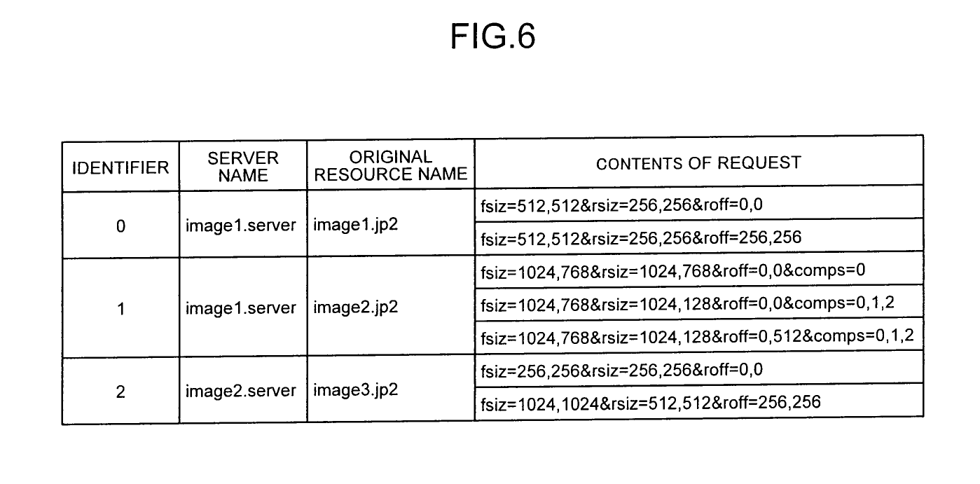

The access control device 11 has the equivalent functions as the access control unit 4 of the first embodiment except that the access control device 11 stores therein an identifier table shown in FIG. 6 instead of the identifier table shown in FIG. 3. The request that is issued by the client device 1 to acquire desired image data by a URI, i.e., the first acquire request is used also in the second embodiment. The access control device 11 generates a third acquire request, instead of the second acquire request, from the first acquire request by referring to the identifier table shown in FIG. 6.

FIG. 6 is an example of the identifier table according to the second embodiment. The identifier table includes identifiers such as 0, 1, 2, 3, and server name, original resource name, and contents of request for each of the identifiers. Particularly, the request contains multiple strings. The second embodiment differs from the first embodiment in enabling the access control device 11 to identify the multiple strings in a request by the single identifier.

The image storage device 13 includes an image-data storage unit 6-1 and a server unit 14. The image storage device 15 includes an image-data storage unit 6-2 and a server unit 16. The image storage device 17 includes an image-data storage unit 6-3 and a server unit 18. Each of the image-data storage units 6-1, 6-2, and 6-3 has the equivalent functions as the image-data storage unit 6 of the first embodiment. Each of the server units 14, 16, and 18 has a function of communicating with the access control device 11 via the network 12, in addition to the equivalent functions as the server unit 5 of the first embodiment. It is assumed that a plurality of pieces of partial image data desired by the client device 1 is stored in one of the image storage devices 13, 15, and 17.

Upon receiving the third acquire request from the access control device 11, the server unit (14, 16, or 18) acquires the pieces of partial image data from the corresponding image-data storage unit (6-1, 6-2, or 6-3) based on the third request, and sends the acquired pieces of partial image data to the access control device 11.

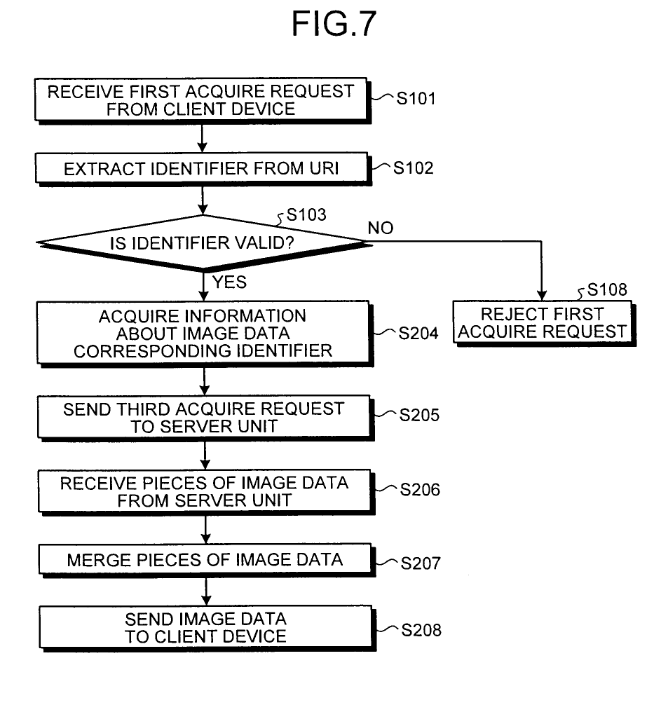

Given below is an explanation about operations of the image distribution system 200 with reference to FIG. 7. FIG. 7 is a flowchart of an image distribution process according to the second embodiment. Steps corresponding to those in the first embodiment shown in FIG. 4 are denoted with the same step numbers. The access control unit 4 of the first embodiment is equivalent to the access control device 11 of the second embodiment.

If the identifier is valid (Yes at Step S103), the access control device 11 acquires the server name, the original resource name, and the contents of request corresponding to the identifier by referring to the identifier table shown in FIG. 6 (Step S204). The access control device 11 generates the third acquire request from the acquired server name, the acquired original resource name, and the acquired strings of details of request, and sends the third acquire request to the server unit(s) corresponding to the acquired server name from among the server units 14, 16, and 18 (Step S205). Each third acquire request can contain a request for a plurality of resources. Alternatively, each third acquire request can contain a request for only one resource, in which case, if there are a plurality of resources, then one third acquire request is generated for each resource.

Upon receiving the third acquire request from the access control device 11, the server unit acquires the pieces of partial image data from the corresponding image-data storage unit based on the third acquire request, and returns the acquired pieces of partial image data to the access control device 11 (Step S205). Upon receiving the pieces of partial image data (Step S206), the access control device 11 merges the received pieces of partial image data (Step S207), and sends the merged partial image data to the client device 1 as a response to the first acquire request (Step S208). If the multiple third acquire requests are generated and the server unit sends the pieces of partial image data one by one at Step S205, the access control device 11 waits until all the pieces of partial image data have been received, and then merges all the pieces of partial image data at Step S207.

In the second embodiment, the access control device 11 identifies, from an identifier received from the client device 1, the corresponding server unit and the pieces of partial image data stored in the corresponding server unit. Thus, it is possible to create the desired image from the pieces of partial image data while maintaining the same effects described in the first embodiment, which makes it possible to build a flexible network that copes with variable image display functions.

The first embodiment and the second embodiment included only one client. In contrast, an image distribution system according to a third embodiment explained in detail below according to the present invention includes a plurality of client devices. Moreover, those client devices can share an image.

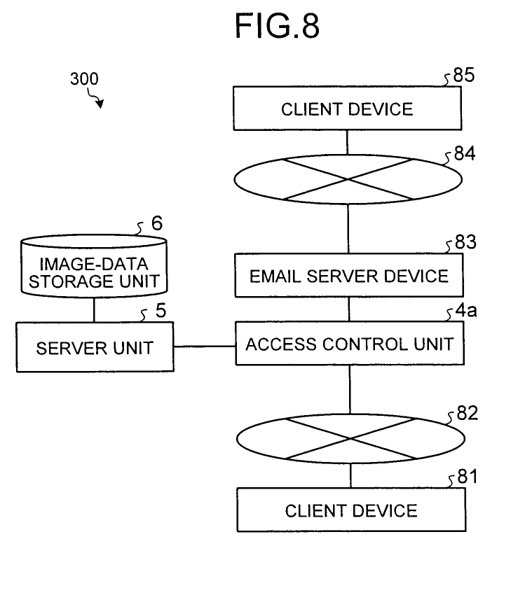

FIG. 8 is a block diagram of an image distribution system 300 according to the third embodiment. The image distribution system 300 uses an access-control method according to the third embodiment. The image distribution system 300 includes a client device 81, a network 82, an access control unit 4a, an email server device 83, the server unit 5, the image-data storage unit 6, a client device 85, and a network 84. The client device 81 is connected to the access control unit 4a via the network 82. The client device 85 is connected to the email server device 83 via the network 84. The access control unit 4a is connected to the email server device 83.

The client device 81 has, in addition to the same functions as the client device 1 of the first embodiment, a share function of requesting the access control unit 4a to make image data shared with a target client device in. The share function enables the client device 81 to upload image data and share the image data with the target client device. It is assumed in the following description that the client device 81 specifies the client device 85 as the target client device with which the image data is to be shared.

The access control unit 4a has the same functions as the access control unit 4 of the first embodiment. Moreover, upon receiving the share request, the access control unit 4a commands the server unit 5 to store the image data uploaded from the client device 81 in the image-data storage unit 6.

The access control unit 4a assigns an identifier to the uploaded image data as appropriately, and stores the identifier in, for example, the identifier table shown in FIG. 3. The access control unit 4a creates a message including information for making the client device 85 accessible to the image data (hereinafter, “permission message”), specifies the client device 85 as the destination of the permission message, and sends the created permission message to the email server device 83.

The email server device 83 sends the permission message to an email address of the client device that is specified by the access control unit 4a as the destination.

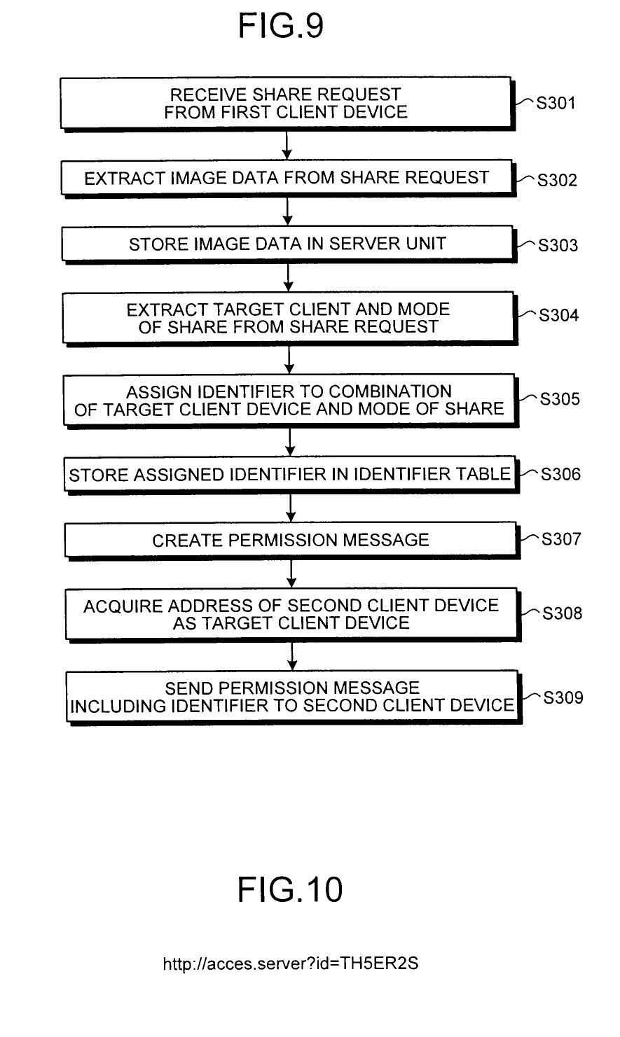

Given below is an explanation about operations of the image distribution system 300 with reference to FIG. 9. FIG. 9 is a flowchart of a sharing process according to the third embodiment. The sharing process starts with a step of receiving the share request and ends with a step of sending the permission message to the target client device. In the following description, the client device 81 issues the share request; the client device 85 is specified as the target client device with which the image data is to be shared. Although only one client device, i.e., the client device 85, is specified as a target client device in the third embodiment, two or more client devices can be specified as the target client devices.

Upon receiving the share request from the client device 81 (Step S301), the access control unit 4a extracts the image data from the share request (Step S302). The share request includes the image data, information indicative of the target client device with which the image data is to be shared, and information indicative of a mode of share. The information indicative of the target client device is, for example, an access role.

The access control unit 4a sends both the image data extracted at Step S302 and a command complied with upload syntax defined by the JPIP to the server unit 5. The server unit 5 stores the received image data in the image-data storage unit 6 based on the received command (Step S303). Details of the syntax are prescribed in “Uploading Images to the Server”, Annex E, ISO/IEC 15444-9.

The access control unit 4a extracts the information indicative of the target client device and the information indicative of the mode of share (Step S304). The mode of share is information about the partial image data to be acquired. The access control unit 4a assigns the identifier to a combination of the information indicative of the target client device and the information indicative of the mode of share both extracted at Step S304 (Step S305).

The access control unit 4a stores the identifier assigned at Step S305 and the information extracted at Step S304 in the identifier table that is described in the first embodiment (Step S306).

The access control unit 4a encrypts the identifier assigned at Step S305 and adds an encrypted character string that is obtained by the encryption to an address of the access control unit 4a, thereby creating the permission message (Step S307). FIG. 10 is an example of the permission message created by the access control unit 4a.

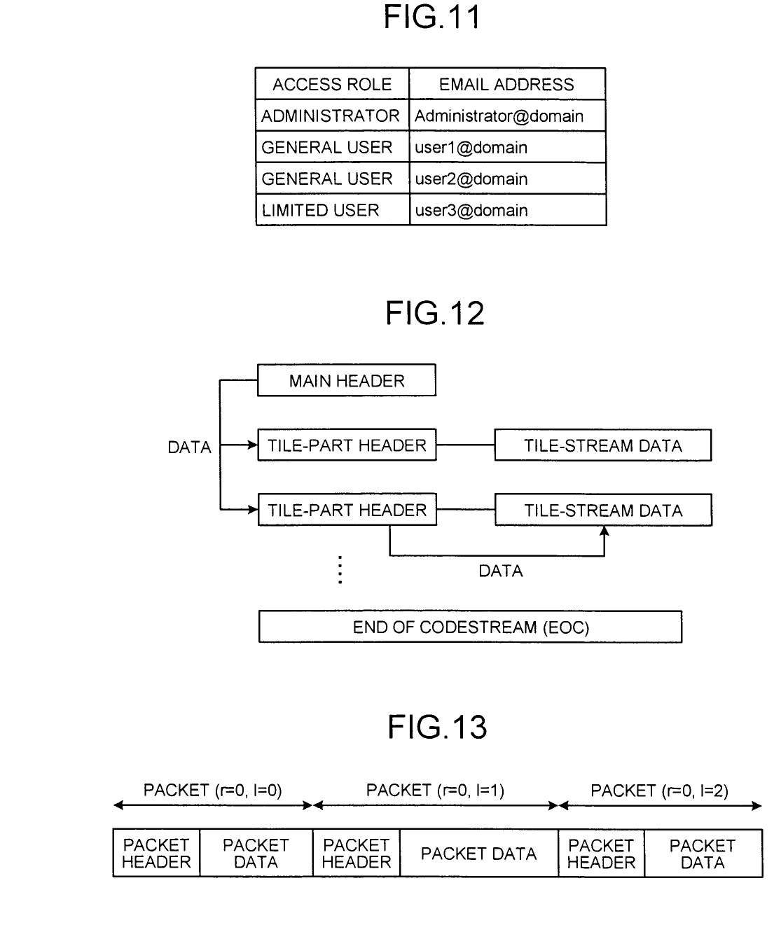

The access control unit 4a acquires an address of the client device 85 by referring to a destination management table shown in FIG. 11 (Step S308), and sends both the permission message and the address of the client device 85 to the email server device 83. FIG. 11 is an example of the destination management table. The destination management table includes email address and access role in an associated manner. Alternatively, the client device 81 directly specifies the email address of the target client device with which the image data is to be shared, and sends the share request including the specified email address to the access control unit 4a. The destination management table is unnecessary in this case.

Upon receiving the permission message, the email server device 83 sends the permission message to the email address of the client device 85 (Step S309).

As a result, the client device 85 receives the permission message, thereby acquiring a link to request the partial image data from the access control unit 4a. The client device 85 requests the partial image data from the access control unit 4a in the same manner as the client device sends the first acquire request in the first embodiment or the second embodiment.

In the third embodiment, upon receiving the share request from the first client device to share the image data with the second client device, the access control unit notifies the second client device of the link to access to the image data. In other words, the first client device specifies the second client device with which the image data is to be shared, and sends the proper link to the second client device, which increases the security in the easy manner.

In the first embodiment, the second embodiment, and the third embodiment, the server unit or the access control unit/device identifies the image data to be acquired from the server device by the identifier extracted from the URI, and sends the minimum coded image data to the client device. In a fourth embodiment of the present invention to be described in detail below, in addition, the image data is encrypted so that the client device can acquire the partial image data.

FIG. 12 is a schematic diagram of the structure of JPEG 2000-based image data. The JPEG 2000-based image data includes codestreams shown in FIG. 12. The codestream starts with a main header and ends with an end of codestream (EOC). A data body located between the main header and the EOC includes a plurality of tile parts. Each tile part includes a tile-part header and tile-stream data. The tile-stream data is a group of packets.

FIG. 13 is a schematic diagram of the structure of the tile-stream data. Each packet includes a packet header and packet data. The packet is partial data indicative of, for example, component, resolution, position, or layer.

There are several ways of sending the partial image data that is made of JPEG 2000-based codestreams by using the JPIP. For example, the first one is sending a piece of partial image data corresponding to each tile part; the second one is rearranging pieces of partial image data based on the tile parts and sending the rearranged pieces of partial image data; and the third one is sending a predetermined amounts of bytes only. Before sending the partial image data with those manners, the partial image data is transformed into a JPIP-based transmission format such as a JPT stream or a JPP stream by using a marker and information about a marker segment extracted from the main header or the tile-part header.

This is why the partial image data is stored in a state that entire codestream except the marker and the marker segment is encrypted. Although no specific encryption scheme is described, various encryption schemes can be used.

In the fourth embodiment, the encrypted image data is obtained by encrypting entire codestream except parts that are required for sending the encrypted image data by using the JPIP. Because the JPIP is useful even if the image data includes the encrypted codestream, it is possible to acquire the partial code only. Thus, the fourth embodiment increases the security while maintaining the effect of acquiring the partial image data.

Although the entire codestream except the marker and the marker segment is encrypted in the fourth embodiment, it is allowable to encrypt only the packet data that forms the data body.

According to an aspect of the present invention, only the necessary data is sent from a server unit to a client device so that it is possible to decrease possibility of transmission delay, workload on a network, and memory usage compared with the conventional technologies. Moreover, security for protecting image data increases. Furthermore, an image distribution system having a simpler structure can be built.

Moreover, a flexible network that copes with variable image display functions can be built. Furthermore, the security increases in an easy manner. Moreover, it is possible to increase the security while maintaining the effect of acquiring the partial image data.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An access control method used in an image distribution system, the image distribution system including a client device and a server device connected to each other via a network, the server device stores therein image data and performs the access control method upon receiving an acquire request from the client device to acquire partial image data, the access control method comprising:
extracting a first identifier from the acquire request, the first identifier being used for identifying the partial image data;
first acquiring including acquiring first information corresponding to the first identifier from an identifier table, wherein the first information is information about the partial image data, and the identifier table includes the first information and the first identifier in an associated manner;
second acquiring including acquiring partial image data corresponding to the first information; and
sending acquired partial image data to the client device via the network.

2. The access control method according to claim 1, further comprising:
determining whether the first identifier extracted at the extracting is valid; and
performing the first acquiring only when it is determined at the determining that the first identifier is valid.

3. The access control method according to claim 1, wherein the client device includes a first client device and a second client device, and the access control method further comprises:
first storing including extracting, upon receiving a share request from the first client device to share image data with the second client device, the image data from the share request and storing the image data;
assigning including extracting third information from the share request and assigning a second identifier to the third information, wherein the third information includes information about the second client device and information about a mode of partial image data to be shared;
second storing including storing the second identifier and the third information in the identifier table in an associated manner; and
creating link information including the second identifier, the link data being used to request the partial image data to be shared; and
notifying the second client device of the link information.

4. The access control method according to claim 1, wherein
the image data is JPEG 2000-based image data, and the image data is transferred using a JPEG 2000 interactive protocol (JPIP).

5. The access control method according to claim 4, wherein the JPEG 2000-based image data includes a main header and a title-part header that includes a marker and a marker segment,
the access control method further comprising encrypting part of the JPEG 2000-based image data other than the marker and the marker segment thereby creating encrypted image data.

6. The access control method according to claim 4, wherein the JPEG 2000-based image data includes tile-stream data that includes packet data,
the access control method further comprising encrypting the packet data thereby creating encrypted image data.

7. The access control method according to claim 4, wherein the first identifier is a target ID that is prescribed in a JPIP standard.

8. An access control method used in an image distribution system including a client device, a plurality of server devices, and an access control device connected to each other via a network, the server devices store therein image data, and the access control device performs the access control method upon receiving an acquire request from the client device to acquire a plurality of pieces of partial image data from one or more of the server devices, the access control method comprising:
extracting a first identifier from the acquire request, the first identifier being used for identifying the partial image data;
first acquiring including acquiring first information corresponding to the first identifier from an identifier table, wherein the first information is information about the partial image data and the second information is information about the one or more server devices that stores therein the partial image, and the identifier table includes the first information, the second information, and the first identifier in an associated manner;
second acquiring including acquiring the pieces of partial image data corresponding to the first information from the one or more server devices corresponding to the second information;
merging the acquired pieces of partial image data thereby obtaining merged image data; and
sending the merged image data to the client device via the network.

9. The access control method according to claim 8, further comprising:
determining whether the first identifier extracted at the extracting is valid; and
performing the first acquiring only when it is determined at the determining that the first identifier is valid.

10. The access control method according to claim 8, wherein the client device includes a first client device and a second client device, and the access control method further comprises:
first storing including extracting, upon receiving a share request from the first client device to share image data with the second client device, the image data from the share request and storing the image data;
assigning including extracting third information from the share request and assigning a second identifier to the third information, wherein the third information includes information about the second client device and information about a mode of partial image data to be shared;
second storing including storing the second identifier and the third information in the identifier table in an associated manner; and
creating link information including the second identifier, the link data being used to request the partial image data to be shared; and
notifying the second client device of the link information.

11. The access control method according to claim 8, wherein
the image data is JPEG 2000-based image data, and
the image data is transferred using a JPEG 2000 interactive protocol (JPIP).

12. The access control method according to claim 11, wherein the JPEG 2000-based image data includes a main header and a title-part header that includes a marker and a marker segment,
the access control method further comprising encrypting part of the JPEG 2000-based image data other than the marker and the marker segment thereby creating encrypted image data.

13. The access control method according to claim 11, wherein the JPEG 2000-based image data includes tile-stream data that includes packet data,
the access control method further comprising encrypting the packet data thereby creating encrypted image data.

14. The access control method according to claim 11, wherein the first identifier is a target ID that is prescribed in a JPIP standard.

15. An access control device used in a server device that is used in an image distribution system, the image distribution system including a client device and the server device connected to each other via a network, the server device stores therein image data, the access control device comprising:
an extracting unit that extracts a first identifier from an acquire request, the first identifier being used for identifying the partial image data, the acquire request being sent from the client device the server device to acquire partial image data from the server device;
a information acquiring unit that acquires first information corresponding to the first identifier from an identifier table, wherein the first information is information about the partial image data, and the identifier table includes the first information and the first identifier in an associated manner;
an image-data acquiring unit that acquires partial image data corresponding to the first information; and
a transmitting unit that transmits the partial image data acquired by the image-data acquiring unit to the client device via the network.

16. The access control device according to claim 15, further comprising a validity determining unit that determines whether the first identifier is valid, wherein
the information acquiring unit acquires first information corresponding to the first identifier only when the validity determining unit determines that the first identifier is valid.

17. The access control device according to claim 15, wherein the client device includes a first client device and a second client device, and the access control device further comprising:
a first storing function including extracting, upon receiving a share request from the first client device to share image data with the second client device, the image data from the share request and storing the image data;
an assigning function including extracting third information from the share request and assigning a second identifier to the third information, wherein the third information includes information about the second client device and information about a mode of partial image data to be shared;
a second storing function including storing the second identifier and the third information in the identifier table in an associated manner; and
a creating function including creating link information including the second identifier, the link data being used to request the partial image data to be shared; and
a notifying function including notifying the second client device of the link information.

18. The access control device according to claim 15, wherein
the image data is JPEG 2000-based image data, and
the image data is transferred using a JPEG 2000 interactive protocol (JPIP).

19. The access control device according to claim 18, wherein the JPEG 2000-based image data includes a main header and a title-part header that includes a marker and a marker segment,
the access control method further comprising encrypting part of the JPEG 2000-based image data other than the marker and the marker segment thereby creating encrypted image data.

20. The access control device according to claim 18, wherein the JPEG 2000-based image data includes tile-stream data that includes packet data,
the access control method further comprising encrypting the packet data thereby creating encrypted image data.
